(19) United States
(12) Patent Application Publication
(10) Pub. No.: US 2011/0266916 A1
(43) Pub. Date: Nov. 3, 2011

(54) TRITIUM BATTERY

(76) Inventors: Raymond S. Donofrio, Sun City, AZ (US); Richard von Hack-Prestinary, Orlando, FL (US); Larry Fullerton, New Hope, AL (US)

(21) Appl. No.: 13/097,984

(22) Filed: Apr. 29, 2011

Related U.S. Application Data
(60) Provisional application No. 61/329,197, filed on Apr. 29, 2010.

(51) Int. Cl. G21H 1/02

(52) U.S. Cl. 310/305

(57) ABSTRACT

A Tritium battery of parallel and aligned thin plate anodes and cathodes separated by thin dielectric panels and enclosed in a vented case with an external dummy load, an integral internal DC-DC converter providing converted output power to external electrical contacts, and a fuse. Logic switches power to the dummy load if there is no load on the external electrical contacts. The cathodes may be coated with an electrically conductive coating, such as graphene or a compound of carbon nanotubes and metallic micro wire. The cathodes may be superconductors. The anode includes a conductive thin plate coated with a chemically stable Tritium compound. The thin plate may be etched to increase surface area. The cases are scalable in configuration and may have ten electrodes or more on the sides as well as ends, and so encased Tritium batteries can be physically stacked side-to-side to create electrical connections for parallel power.

### RELATED APPLICATIONS

The present application claims the benefit of provisional application Ser. No. 61/329,187 filed Apr. 29, 2010 by the same inventors.

### TECHNICAL FIELD

The present invention is related to an improved modular Tritium battery design that exploits advanced materials and allows cell stacking to achieve desired voltage and/or amperage necessary to sustain work. Some examples of such a storage device need include: electronic solid state devices, mobile phones, a laptop computer, a personal digital assistant (PDA), a camera, a television, a portable media player, unmanned systems, and an automobile.

### BACKGROUND

A traditional battery is a device that converts the chemical energy contained in its active materials into electrical energy by means of an electrochemical reaction. While the term “battery” is often used, the basic electrochemical element being referred to is the battery cell. A battery consists of two or more cells electrically connected in series to form a unit. In common usage, the terms “battery” and “cell” are used interchangeably. A traditional battery design falls within two categories being primary or secondary. Primary batteries can be used only once because the chemical reactions that supply the electrical current are irreversible. Secondary (or storage) batteries can be used, charged, and reused. In these batteries, the chemical reactions that supply electrical current are readily reversed so that the battery is charged.

A traditional battery uses a separator to electrically isolate the positive and negative electrodes. If the electrodes are allowed to come in contact, the cell will short-circuit and become useless because both electrodes would be at the same potential. It should be noted that the electrodes in a battery must be of dissimilar materials or the cell will not be able to develop an electrical potential and thus conduct electrical current. The type of separator used varies by cell type. Materials used as separators must allow electron transfer between the electrodes. The separator is made of a porous plastic or glass fiber material. The above components are housed in a container commonly called a jar or container. The electrolyte completes the internal circuit in the battery by supplying ions to the positive and negative electrodes. Dilute sulfuric acid (H₂SO₄) is the electrolyte in lead-acid batteries. In a fully charged lead-acid battery, the electrolyte is approximately 25% sulfuric acid and 75% water.

Beta-voltaic batteries collect and channel sub-atomic particles from radioactive decay. The term “Tritium Battery” is often used wherein the basic electrochemical element being referred to is the battery cell. A battery consists of two or more cells electrically connected in series to form a unit. In common usage, the terms “battery” and “cell” are used interchangeably.

### OBJECTS AND FEATURES OF THE INVENTION

It is an object and feature of the present invention to provide four cell and battery designs, each embodiment more energetic than its predecessor and similar in application to their analogues, i.e. standard cell, alkaline cell, and the Lithium cell batteries. The three advantages for the Tritium power cells are: they're always producing power, they never will need to be recharged, and battery life is extended for a period of approximately twenty-four years

Another object and feature of the present invention is to provide immunity to extreme temperature fluctuations. The Tritium battery will produce power consistently at temperatures ranging from near absolute zero (minus 273 degrees Celsius) to well over 100 degrees Celsius. This means that, for this Tritium battery, function will no longer be limited by temperature based environmental factors: it will produce predictable and consistent power over its design life.

### SUMMARY OF THE INVENTION

The invention provides a tritium battery including a stack of a plurality of thin plate cathodes alternated with a plurality of thin plate anodes, a plurality of thin dielectric layers separating the plurality of thin plate cathodes alternated with the plurality of thin plate anodes, where each the anode of the plurality of thin plate anodes includes a coating of a chemically stable tritium compound on a thin metallic panel; and where first and second opposing ends of the stack each terminate in a cathode. The tritium battery, where the thin metallic panel includes an etched thin metallic panel. The tritium battery, further including a case enclosing the stack. The tritium battery, further including a vent in the case operable to vent ³He without allowing air or water to enter the case. The tritium battery, further including an integral DC-DC converter inside the case for accepting an electrical output from the stack and for providing converted electrical output to either first and second external electrodes mounted at least partially eternally on the case or a dummy load mounted external to the case. The tritium battery, including a fuse in the converted electrical output path. The tritium battery, further including a logic operable to switch the converted electrical output between the first and second external electrodes and the dummy load responsive to the state of an electrical load on the first and second external electrodes. The tritium battery, where the first and second external electrodes each include first and second electrical side contacts mounted circumferentially on at least first and second side portions of the case proximate to first and second opposing case ends, respectively, or the first and second electrical contacts mounted on the first and second opposing case ends. The tritium battery, further including a plurality of the tritium batteries having a respective plurality of first and second electrical side contacts stacked with the plurality of the first side electrical contacts in electrical contact with each other and the plurality of the second electrical side contacts in electrical contact with each other. The tritium battery, further including an electrically conductive coating on each cathode. The tritium battery, further including a case enclosing the stack; a vent in the case operable to vent ³He without allowing air or water to enter the case; an integral DC-DC converter inside the case for accepting an electrical output from the stack and for providing converted electrical output to one of first and second external electrodes mounted at least partially eternally on the case; a dummy load mounted external to the case; logic operable to switch to the converted electrical output between the first and second external electrodes and the dummy load responsive to the state of an electrical load on the first and second external electrodes. The tritium battery, where the electrically conductive coating includes either graphene or a carbon nanotube and micro silver wire compound. The tritium battery, where the first and second external electrodes each include either first and second electrical side contacts mounted circumferentially on at least first and second side portions of the case proximate to first and second opposing case ends, respectively, and the first and second electrical contacts mounted on the first and second opposing case ends. The tritium battery, further including a plurality of the tritium batteries having a respective plurality of first and second electrical side contacts stacked with the plurality of the first side electrical contacts in electrical contact with each other and the plurality of the second electrical side contacts in electrical contact with each other. The tritium battery, including an electrically conductive coating on each cathode and where the thin metallic panel is replaced with a thin panel of superconducting material. The tritium battery, further including a case enclosing the stack; a vent in the case operable to vent ³He without allowing air or water to enter the case; an integral DC-DC converter inside the case for accepting an electrical output from the stack and for providing converted electrical output to one of first and second external electrodes mounted at least partially eternally on the case; a dummy load mounted external to the case; logic operable to switch to the converted electrical output between the first and second external electrodes and the dummy load responsive to the state of an electrical load on the first and second external electrodes. The tritium battery, further including a plurality of the tritium batteries having a respective plurality of first and second electrical side contacts stacked with the plurality of the first side electrical contacts in electrical contact with each other and the plurality of the second electrical side contacts in electrical contact with each other. The tritium battery, where the electrically conductive coating includes either graphene or a carbon nanotube and micro silver wire compound.

A tritium battery including a stack including a plurality of parallel and aligned thin plate cathodes alternated with a plurality of parallel and aligned thin plate anodes; a plurality of thin dielectric layers separating the plurality of thin plate cathodes alternated with the plurality of thin plate anodes; where each anode of the plurality of thin plate anodes includes a coating of a chemically stable tritium compound on a thin metallic panel; where first and second opposing ends of the stack each terminate in a cathode; a case enclosing the stack; a vent in the case operable to vent ³He without allowing air or water to enter the case; an integral DC-DC converter inside the case for accepting an electrical output from the stack and for providing converted electrical output to either first and second external electrodes mounted at least partially eternally on the case or a dummy load mounted external to the case; a fuse in a path of the converted electrical output; logic operable to switch the converted electrical output between the first and second external electrodes and the dummy load responsive to the state of an electrical load on the first and second external electrodes.

A tritium battery including a stack of a plurality of parallel and aligned thin plate cathodes alternated with a plurality of parallel and aligned thin plate anodes; a plurality of thin dielectric layers separating the plurality of thin plate cathodes alternated with the plurality of thin plate anodes where each anode of the plurality of thin plate anodes includes a coating of a chemically stable tritium compound on a thin superconductive panel; where first and second opposing ends of the stack each terminate in a cathode; a case enclosing the stack; a vent in the case operable to vent ³He without allowing air or water to enter the case; an integral DC-DC converter inside the case for accepting an electrical output from the stack and for providing converted electrical output to one of first and second external electrodes mounted at least partially externally on the case; and a dummy load mounted external to the case; a fuse in a path of the converted electrical output; a logic operable to switch the converted electrical output between the first and second external electrodes and the dummy load responsive to the state of an electrical load on the first and second external electrodes; an electrically conductive coating on each the cathode; and where the first and second external electrodes each include first and second electrical side contacts mounted circumferentially on at least first and second side portions of the case proximate to first and second opposing case ends, respectively.

Additional aspects of the invention will be set forth, in part, in the detailed description, figures which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The above and other objects and advantages of the present invention will become more apparent from the following description taken in conjunction with the following drawings in which:

FIG. 1 is a diagrammatic view illustrating an exemplary improved Tritium Beta-voltaic battery cell, in accordance with a preferred embodiment of the present invention;

FIG. 2 is a diagrammatic view illustrating a second exemplary improved Tritium Beta-voltaic battery cell, in accordance with a preferred embodiment of the present invention;

FIG. 3 is a diagrammatic view illustrating a third exemplary improved Tritium Beta-voltaic battery cell, in accordance with another preferred embodiment of the present invention;

FIG. 5A is a top plan view illustrating a second exemplary packaged cell, in accordance with a preferred embodiment of the present invention;

FIG. 5B is a bottom plan view illustrating the exemplary packaged cell of FIG. 5A, in accordance with a preferred embodiment of the present invention;

FIG. 6 is a side elevation view illustrating an exemplary parallel stack of exemplary packaged cells of FIGS. 5A and 5B; and

FIG. 7 is a side elevation view illustrating an exemplary series stack of exemplary packaged cells of FIGS. 5A and 5B.

### DETAILED DESCRIPTION

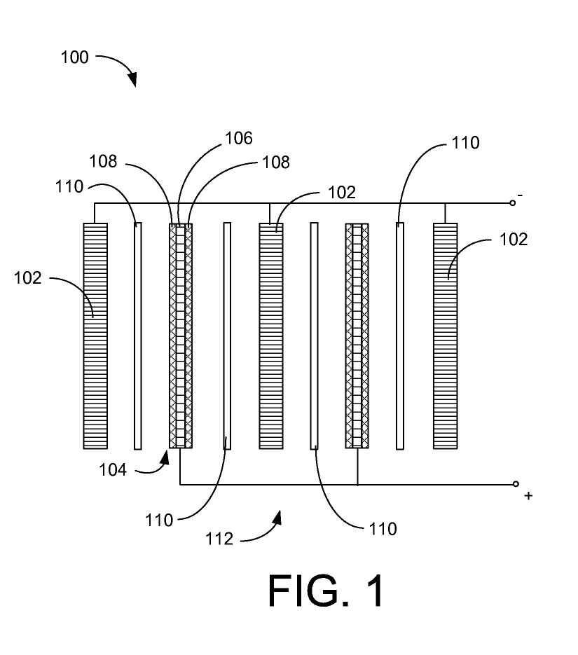

FIG. 1 is a diagrammatic view illustrating an exemplary improved Tritium Beta-voltaic battery cell 100, in accordance with a preferred embodiment of the present invention. Negative electrode 102 supplies electrons to the external circuit (or load) during discharge. In a fully charged Tritium Beta voltaic battery cell 100, the negative electrode 102 is composed of a conductive metal plate. As the negative electrode 102 supplies electrons, it becomes more and more positive from the load (not shown) during discharge. A fully charged Tritium battery positive electrode 104 (one of two labeled) is composed of a conductive metal piece 106 coated with a stable Tritium-based compound 108. For example, the Tritium-based compound 108 may be Tritium hydride. Between the negative electrode (cathode) 102 and the positive electrode (anode) 104, there is a thin dielectric layer 110 of dielectric material of sufficiently low density to permit beta particle (emitted electron) permeability between the electrodes 102, 104.

The dielectric layer 110 prevents the transfer of ambient (low kinetic energy) electrons between the cathode 104 and the anode 102, while allowing beta particles (high kinetic energy electrons) to pass from the cathode 104 to the anode 102. Tritium is chemically bound (for example, in a hydride compound) for stable chemical retention and abated migration of Tritium, prevention of potential leakage, and maintaining consistent battery power generation. The gaps shown between the dielectric layers 110 and the electrodes 102, 104, are only for purposes of illustration: in practice, the dielectric layers and electrodes are in contact. This mode of illustration is used throughout the drawings. The cathodes 104 are never on the outside of the capacitor-like structure 112.

In a particular embodiment, the surfaces of electrodes 102, 106 may be etched, as is known in the art of making conductors for ultra capacitors, to increase the surface area of the electrode 102, 106, and thereby increase their charge-holding capacity. In another particular embodiment, the cathode plates 106 may be sintered metal, enabling venting of ³He gas through the cathode.

The capacitor-like structure 112 is constructed such that every other conducting layer 102, 104 is coated with a thin layer of tritium compound 108. In the present embodiment, the Tritium compound 108 would be a specially formulated Tritium compound 108. The tritium compound 108 emits beta particles (electrons) at a predictable rate proportional to the density of the tritium compound 108 and its age in half-lives. If the insulation layers 110 of the capacitor 112 are thin enough, then energized electrons (beta particles) will penetrate the dielectric insulation layers 110 and pass through to the cathode conductor plate 102 on the other side, enabling current flow. The anode conductor plates 106 are coated with tritium compound 108 and will, therefore, lose electrons and become positively charged and the cathode conductor plates 102 receiving the electrons will become negatively charged. As the electrode conductor 102, 106 plates become charged, the emitted electrons will have to do work in order to make it through to the other side of the insulation layer 110: this is the source of power in the Tritium Beta-voltaic battery cell 100. Since the Tritium Beta-voltaic battery cell must develop substantial voltage in the range of several thousand volts, a practical device will contain an integral DC-DC converter that efficiently converts the high voltage at low current to a low voltage at higher current, i.e. 12 VDC at 1 mA gives a power output of 12 mW.

A balance of competing considerations is required. The dielectric strength of insulation layers 110 increases as approximate thickness, so Tritium Beta-voltaic battery cell 100 voltage increases linearly with thickness. Since power is proportional to voltage squared, power increases as thickness of the dielectric layers 110 is squared. However, beta penetration efficiency decreases rapidly with thickness, so current decreases with thickness. Accordingly, there is a competing requirement to make the dielectric layer 110 as thick as possible to allow operation at the highest possible voltage, since energy is proportional to voltage squared, but also as thin as possible to allow as many beta particles to penetrate the dielectric layer 110 as possible, since that constitutes the current. The power is the product of the operating voltage times the current. Thus, for a given dielectric layer 110 material, the Tritium Beta-voltaic battery cell's 100 power output has a maxima dependent on its transparency to beta particles. The insulating layers 110 are therefore made of high dielectric strength material so that they can be made as thin as possible and the dielectric material is also chosen to be as transparent as possible to beta particles in the energy range emitted by tritium. When these two requirements are properly balanced, then the battery will produce the maximum power possible.

The Tritium Beta-voltaic battery cell 100 will convert its mass of tritium into ³He. The latter is completely harmless but provision must be made to vent ³He or build-up of ³He in the Tritium Beta-voltaic battery cell 100 will cause damage. ³He can be dissolved in various materials and will slowly diffuse through such materials, so including such materials in the Tritium Beta-voltaic battery cell 100 construction will scavenge exhaust ³He gas and thereby allow such gas to diffuse through the Tritium Beta-voltaic battery cell 100 into the atmosphere. For example, palladium dissolves a relatively large amount of helium as does iron to a lesser degree. An alternative method of venting the helium is to embed microscopic tubes that act as pipes to allow the ³He to exit but keep foreign matter out of the cell. The same effect can be obtained by using porous media such as sintered materials or zeolytes. Finally, nanotubes can be used that are crafted to allow the transport of molecules the size of helium to escape but to block any larger molecules such as air or water from entering the cell.

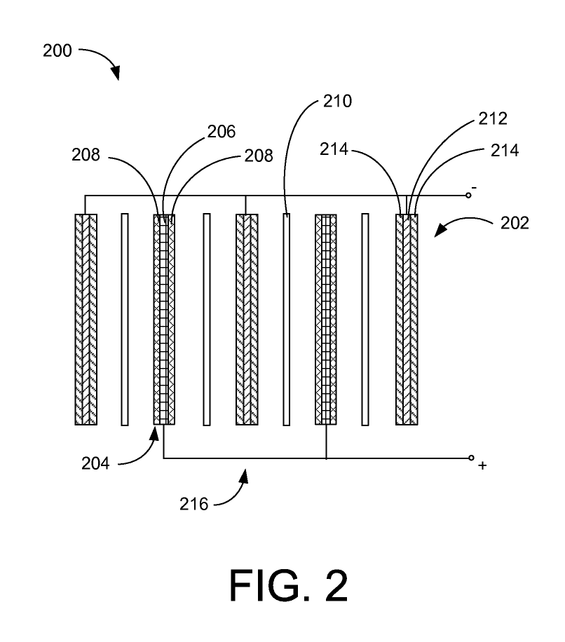

FIG. 2 is a diagrammatic view illustrating an exemplary improved Tritium Beta-voltaic battery cell 200 having improved capacity, in accordance with a preferred embodiment of the present invention. The embodiment of FIG. 2 deviates from the embodiment of FIG. 1 by first, integrating a metal foil layer 212 that conducts the received electrons to the cathode 202 and, secondly, by integrating conductive carbon nanotubes/micro silver wire compound coating 214 on metal foil layer 212. In an alternate embodiment, graphene may be used in place of the conductive carbon nanotubes/micro silver wire compound coating 214.

The Tritium Battery device 200 of the present embodiment is made possible, in part, by the use of nano-technology. A capacitor-like structure 216 is constructed such that every other conducting layer 206, 212 is coated with a thin layer of tritium compound 208, for example, a Tritium Hydride compound 208. The Tritium compound 208 emits beta particles (electrons) at a predictable rate proportional to the density of the Tritium compound 208 and its age in half-lives. If the dielectric layers 210 of the capacitor-like structure 216 are thin enough, then the electrons will penetrate the dielectric insulation layers 210 and pass through to the cathode conductor 212 on the other side. A dielectric material of sufficient thinness with high beta particle permeability is preferred. The anode conductor plates 206 coated with a tritium compound 208 will therefore lose electrons and become positively charged and the graphene or Carbon nanotube/micro Silver wire-coated 214 cathode conductors 212 receiving the electrons will become negatively charged. As the anode and cathode conductor plates 206, 212 become charged, the emitted electrons will have to do work in order to make it through to the other side of the dielectric layers; this is the source of power in the Tritium Beta-voltaic battery cell 200. Since the Tritium Beta-voltaic battery cell 200 must develop substantial voltage in the range of several thousand volts, a practical device will contain an integral DC-DC converter that efficiently converts the high voltage at low current to a low voltage at higher current, i.e. 12 VDC at 1 mA gives a power output of 12 mW. In this embodiment of the improved Tritium Beta-voltaic battery cell using Carbon nanotube/micro Silver wire coated 214 conductors 212, battery efficiency is substantially increased.

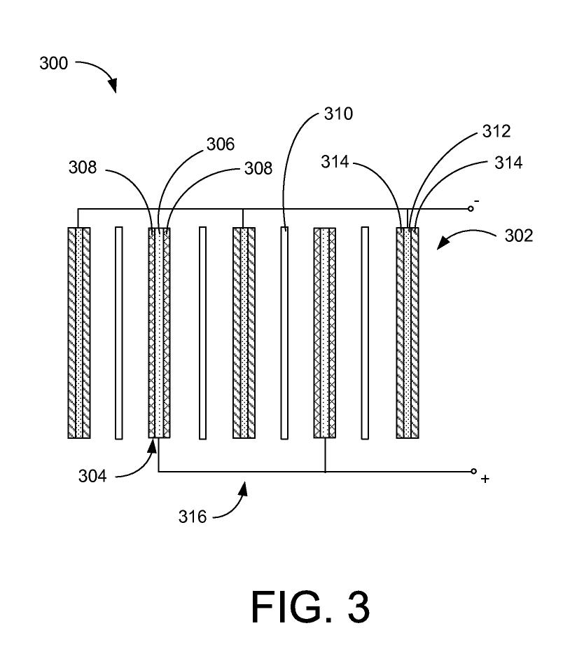

FIG. 3 is a diagrammatic view illustrating a third exemplary improved Tritium Beta-voltaic battery cell 300, in accordance with another preferred embodiment of the present invention. The present embodiment deviates from the embodiment of FIG. 1 by first, integrating superconducting layers 306 and 312 and, secondly, integrating conductive carbon nanotubes/micro silver wire compound coating 314. In an alternate embodiment, graphene may be used in place of the conductive carbon nanotubes/micro silver wire compound coating 314. A capacitor-like structure 316 is constructed such that every other superconducting anode layer 306, is coated with a thin layer of tritium compound 308, for example, a Tritium Hydride compound 308. The Tritium compound 308 emits beta particles (electrons) at a predictable rate proportional to the density of the Tritium compound 308 and the age of the Tritium compound 308 in half-lives. If the dielectric layers 310 of the capacitor-like structure 316 are thin enough, then the emitted electrons will penetrate the dielectric layers 310 and pass through to the cathode superconductor 312 on the other side of the dielectric layer 310. The superconducting anodes 312 are coated with a tritium compound 308 and will, therefore, lose electrons and become positively charged and the graphene or Carbon nanotube/micro Silver wire coated 314 cathode superconductors 312 receiving the electrons will become negatively charged. As the superconductor plates 306, 312 become charged, the emitted electrons will have to do work in order to make it through to the other side of the dielectric layer 310; this is the source of power in the Tritium Beta-voltaic battery cell 300.

Since the Tritium Beta-voltaic battery cell 300 must develop substantial voltage in the range of several thousand volts, a practical device will contain an integral DC-DC converter that efficiently converts the high voltage at low current to a low voltage at higher current, i.e. 12 VDC at 1 mA gives a power output of 12 mW. In this instantiation of the Tritium battery using a room temperature superconducting substrate and Carbon nanotube/micro Silver wire coated conductors, battery efficiency dramatically increases.

The Tritium Beta-voltaic battery cells 100, 200, or 300 may be connected in series, parallel, or combinations of both packaging alternatives. Similar cells or batteries connected in series have the positive terminal of one cell or battery connected to the negative terminal of another cell or battery. This has the effect of increasing the overall voltage but the overall current capacity remains the same. Similar cells or batteries connected in parallel have their like terminals connected together. The overall voltage remains the same but the current capacity is increased.

FIG. 4 is a diagrammatic view illustrating an exemplary packaged cell 400 of the third exemplary improved Tritium Beta-voltaic battery cell 300 of FIG. 3, in accordance with another preferred embodiment of the present invention. Package wall 426, which may be a cylindrical wall, is an insulator. In other embodiments, the package wall may have various shapes adapted to various applications. Anode 424 is shown as a flat plate for stacking packaged cells 400. In various other embodiments, the anode 424 may be of various shapes adapted to various applications. Cathode 422 is shown as a flat plate for stacking packaged cells 400. In various other embodiments, the cathode 422 may be of various shapes adapted to various applications. Packaged cell 400 contains DC/DC converter 420 for converting from high voltage with a low current to lower voltage at a higher current. In an alternate embodiment, the DC/DC converter is a separate module sized for a particular stack of packaged cells 400. Tritium Beta-voltaic battery cell 300 has anode 306 and cathode 304 coupled to the inputs of the DC/DC converter 420. The anode output lead 428 from DC/DC converter 420 couples to packaged cell 400 anode 422, while the cathode output lead 430 428 from DC/DC converter 420 couples to packaged cell 400 anode 424.

Those of skill in the art, informed by this disclosure, will appreciate that embodiments using superconductors 306, 312 must be operated within the temperature range at which the particular superconducting material superconducts. For example, if a room-temperature superconducting material were to be employed, the Tritium Beta-voltaic battery cell 300 would have to be maintained at room temperature, making it preferable to place the dummy load outside of the packaged cell 400.

Package wall 426 may have one or more vents (not shown) for venting ³He. Means for venting ³He while preventing the entry of moisture, such as permeable membranes, are preferred.

The Tritium Beta-voltaic battery cell 100, 200, and 300, as well as embodiments not illustrated, may be packaged to have the size, shape, and electrical output of a conventional battery, such as commercially available cell phone cells, or any other size and shape of battery desired. For further example, the Tritium Beta-voltaic battery cells 100, 200, or 300 may be packaged on integrated circuit chips for use in powering circuits on circuit boards. In addition, the Tritium Beta-voltaic battery cells 100, 200, or 300 may be packaged with other circuit components for power management, such as an ultra capacitor. In a particular application, a dummy load may included with packaged cell 400, as the Tritium Beta-voltaic battery cell 300 is constantly generating electrical charge and there must always be a path for the current being produced. In an exemplary embodiment, the dummy load is on the package wall 426, and is automatically switched in when the primary load is not drawing current. Heat dissipation means may be incorporated with the dummy load.

In an exemplary application, a flashlight using a Tritium Beta-voltaic battery cells 100, 200, or 300 may omit an ON/OFF switch and remain constantly on, there being no point in conserving beta-voltaic battery power. In such a flashlight, the load includes an array of flashlight bulbs connected in parallel, so that the load may be maintained as individual bulbs burn out and are replaced. This approach may be used for various lighting and surveillance applications. Those of skill in the art, enlightened by the present disclosure, with appreciate other uses for constantly loaded Tritium batteries in applications previously characterized by intermittent loading.

In an exemplary hybrid battery embodiment, the packaged cell 400 may be used to trickle charge a lithium-ion battery either as an integral part of the lithium-ion battery or as a separate component. In an exemplary power supply, the packaged cell 400 may be coupled to an ultra capacitor or lithium-ion battery for storage via charge-control circuitry, a DC/DC converter for current management, and a dummy load that can be switched in if the primary load fails. The dummy load can be a resistor, or a resistor with a fan for dissipating the heat.

The packaged cell 400 is designed for modularity.

Tritium Beta-voltaic battery cells 100, 200, and 300, like most traditional cells or batteries are designed to support a functional, mechanical and electrical product interface. As with traditional batteries, for a Tritium Beta-voltaic battery cell 100, 200, and 300 or battery to deliver electrical current to an external circuit, a potential difference must exist between the positive and negative electrodes. The potential difference (usually measured in volts) and is commonly referred to as the voltage of the cell or battery. Like traditional batteries, the capacity of a Tritium Beta-voltaic battery cell/battery is defined as the amount of charge available expressed in ampere-hours (Ah). An ampere is defined as the unit of measurement used for electrical current and is defined as a coulomb of charge passing through an electrical conductor in one second. The capacity of a cell or battery is related to the quantity of active materials in it, and the amount of electrolyte and the surface area of the electrode plates. The capacity of a battery/cell is measured by discharging at a constant current until it reaches its terminal voltage. This measurement is performed at a constant temperature, under standard conditions of 25° C. (77° F.). The capacity is calculated by multiplying the discharge current value by the time required to reach terminal voltage.

In a fourth embodiment, Tritium can also be used in gas form to construct a packed cell 400 by enclosing the Tritium gas within a packaged cell made of very thin insulating material that is plated on the outside with a metal. If a conductor is inserted inside the gas-filled cell that is insulated from the metal cladding on the outside, then current will flow between the conductor (+ polarity) to the metal cladding (− polarity) and form a battery cell. Low power applications may make use of this simple construction technique at the cost of lower power density, i.e. larger size.

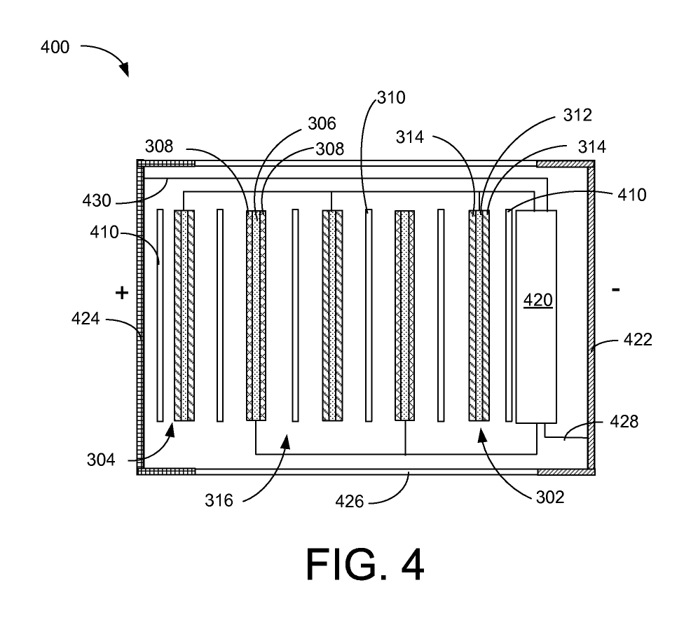

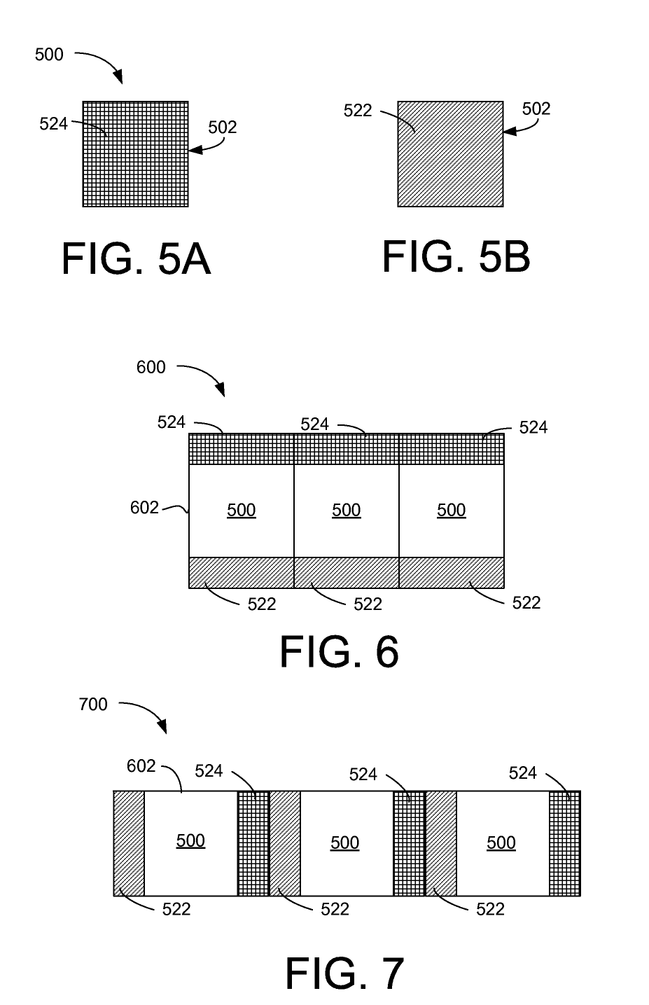

FIG. 5A is a top plan view illustrating a second exemplary square-packaged cell 500, in accordance with a preferred embodiment of the present invention. Square-packaged cell 500 has a square exterior perimeter 502, rectangular sides 602 (See FIGS. 6 and 7), and cathode 524, which covers the top and extends along at least two opposing sides of square-packaged cell 500. The square exterior perimeter 502 does not require that the Tritium Beta-voltaic battery cells 100, 200, 300 or other, non-illustrated embodiments, have the same cross-sectional shape. For example, a Tritium Beta-voltaic battery cell 300 within square-packaged cell 500 may have a round cross-section, with the vacant corners used for circuitry such as ultra capacitors, Lithium Ion batteries, fuses, current limiters, dummy loads, and DC/DC converters.

FIG. 5B is a bottom plan view illustrating the exemplary square-packaged cell 500 of FIG. 5A, in accordance with a preferred embodiment of the present invention. Anode 522 covers the bottom and extends along at least two opposing sides 602 of square-packaged cell 500. While cathode 524 and anode 522 are illustrated as flat, any shaping to improve electrical contact and provide conformal anodes 522 and cathodes 524 for stacking of packaged cells 500 is within the scope of the present invention.

FIG. 6 is a side elevation view illustrating an exemplary parallel stack 600 of exemplary packaged cells 500 of FIGS. 5A and 5B. The parallel stack 600 of three square-packaged cells 500 increases current at constant voltage. If the anodes 522 and cathodes 524 extend along all four sides 602 of each square-packaged cell 500, three-dimensional stacking is possible. In stack 600, 700, or two-dimensional or three-dimensional combinations thereof, fusing of individual square-packaged cells 500 is preferred, as a shorted square-packaged cells 500 anywhere in the stack 600 or 700 would short the entire stack 600, 700.

FIG. 7 is a side elevation view illustrating an exemplary series stack 700 of exemplary packaged cells 500 of FIGS. 5A and 5B. A series stack 700 increases voltage at constant current. Stacks 600 and 700 are not limited to three square-packaged cells 500, and may be combined to form two-dimensional arrays or even three-dimensional arrays of square-packaged cells 500.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A tritium battery comprising:
a. a stack of a plurality of thin plate cathodes alternated with a plurality of thin plate anodes;
b. a plurality of thin dielectric layers separating said plurality of thin plate cathodes alternated with said plurality of thin plate anodes;
c. wherein each said anode of said plurality of thin plate anodes comprises a coating of a chemically stable tritium compound on a thin metallic panel; and
d. wherein first and second opposing ends of said stack each terminate in a cathode.

2. The tritium battery of claim 1, wherein said thin metallic panel comprises an etched thin metallic panel.

3. The tritium battery of claim 1, further comprising a case enclosing said stack.

4. The tritium battery of claim 3, further comprising at least one vent in said case operable to vent ³He without allowing air or water to enter said case.

5. The tritium battery of claim 3, further comprising an integral DC-DC converter inside said case for accepting an electrical output from said stack and for providing converted electrical output to one of:
a. first and second external electrodes mounted at least partially externally on said case; and
b. a dummy load mounted external to said case.

6. The tritium battery of claim 5, comprising a fuse in said converted electrical output path.

7. The tritium battery of claim 5, further comprising a logic operable to switch said converted electrical output between said first and second external electrodes and said dummy load responsive to the state of an electrical load on said first and second external electrodes.

8. The tritium battery of claim 5, wherein said first and second external electrodes each comprise at least one of:
a. first and second electrical side contacts mounted circumferentially on at least first and second side portions of said case proximate to first and second opposing case ends, respectively; and
b. said first and second electrical contacts mounted on said first and second opposing case ends.

9. The tritium battery of claim 8, further comprising a plurality of said tritium batteries having a respective plurality of first and second electrical side contacts stacked with said plurality of said first side electrical contacts in electrical contact with each other and said plurality of said second electrical side contacts in electrical contact with each other.

10. The tritium battery of claim 1, further comprising an electrically conductive coating on each said cathode.

11. The tritium battery of claim 10, further comprising:
a. a case enclosing said stack;
b. at least one vent in said case operable to vent ³He without allowing air or water to enter said case;
c. an integral DC-DC converter inside said case for accepting an electrical output from said stack and for providing converted electrical output to one of:
i. first and second external electrodes mounted at least partially externally on said case;
ii. a dummy load mounted external to said case; and
d. a logic operable to switch to said converted electrical output between said first and second external electrodes and said dummy load responsive to the state of an electrical load on said first and second external electrodes.

12. The tritium battery of claim 10, wherein said electrically conductive coating comprises at least one of:
a. graphene; and
b. a carbon nanotube and micro silver wire compound.

13. The tritium battery of claim 10, wherein said first and second external electrodes each comprise at least one of:
a. first and second electrical side contacts mounted circumferentially on at least first and second side portions of said case proximate to first and second opposing case ends, respectively; and
b. said first and second electrical contacts mounted on said first and second opposing case ends.

14. The tritium battery of claim 10, further comprising a plurality of said tritium batteries having a respective plurality of first and second electrical side contacts stacked with said plurality of said first side electrical contacts in electrical contact with each other and said plurality of said second electrical side contacts in electrical contact with each other.

15. The tritium battery of claim 1, comprising an electrically conductive coating on each said cathode and wherein said thin metallic panel is replaced with a thin panel of superconducting material.

16. The tritium battery of claim 15, further comprising:
a. a case enclosing said stack;
b. at least one vent in said case operable to vent ³He without allowing air or water to enter said case;
c. an integral DC-DC converter inside said case for accepting an electrical output from said stack and for providing converted electrical output to one of:
i. first and second external electrodes mounted at least partially externally on said case;
ii. a dummy load mounted external to said case; and
d. a logic operable to switch to said converted electrical output between said first and second external electrodes and said dummy load responsive to the state of an electrical load on said first and second external electrodes.

17. The tritium battery of claim 15, further comprising a plurality of said tritium batteries having a respective plurality of first and second electrical side contacts stacked with said plurality of said first side electrical contacts in electrical contact with each other and said plurality of said second electrical side contacts in electrical contact with each other.

18. The tritium battery of claim 15, wherein said electrically conductive coating comprises at least one of:
a. graphene;
b. a carbon nanotube and micro silver wire compound.

19. A tritium battery comprising:
a. a stack comprised of a plurality of parallel and aligned thin plate cathodes alternated with a plurality of parallel and aligned thin plate anodes;
b. a plurality of thin dielectric layers separating said plurality of thin plate cathodes alternated with said plurality of thin plate anodes;
c. wherein each said anode of said plurality of thin plate anodes comprises a coating of a chemically stable tritium compound on a thin metallic panel;
d. wherein first and second opposing ends of said stack each terminate in a cathode;
e. a case enclosing said stack;
f. at least one vent in said case operable to vent ³He without allowing air or water to enter said case;
g. an integral DC-DC converter inside said case for accepting an electrical output from said stack and for providing converted electrical output to one of:
i. first and second external electrodes mounted at least partially externally on said case; and
ii. a dummy load mounted external to said case;
h. a fuse in a path of said converted electrical output; and
i. a logic operable to switch said converted electrical output between said first and second external electrodes and said dummy load responsive to the state of an electrical load on said first and second external electrodes.

20. A tritium battery comprising:
a. a stack comprised of a plurality of parallel and aligned thin plate cathodes alternated with a plurality of parallel and aligned thin plate anodes;
b. a plurality of thin dielectric layers separating said plurality of thin plate cathodes alternated with said plurality of thin plate anodes;
c. wherein each said anode of said plurality of thin plate anodes comprises a coating of a chemically stable tritium compound on a thin superconductive panel;
d. wherein first and second opposing ends of said stack each terminate in a cathode;
e. a case enclosing said stack;
f. at least one vent in said case operable to vent ³He without allowing air or water to enter said case;
g. an integral DC-DC converter inside said case for accepting an electrical output from said stack and for providing converted electrical output to one of:
i. first and second external electrodes mounted at least partially externally on said case; and
ii. a dummy load mounted external to said case;
h. a fuse in a path of said converted electrical output;
i. a logic operable to switch said converted electrical output between said first and second external electrodes and said dummy load responsive to the state of an electrical load on said first and second external electrodes;
j. an electrically conductive coating on each said cathode; and
k. wherein said first and second external electrodes each comprise first and second electrical side contacts mounted circumferentially on at least first and second side portions of said case proximate to first and second opposing case ends, respectively.
